(19) United States
(12) Patent Application Publication
(10) Pub. No.: US 2017/0229848 A1
(43) Pub. Date: Aug. 10, 2017

(54) WIRE GUIDE ASSEMBLY

(71) Applicant: Todd Barnhill, Alpine, CA (US)

(72) Inventor: Todd Barnhill, Alpine, CA (US)

(21) Appl. No.: 15/491,975

(22) Filed: Apr. 20, 2017

(51) Int. Cl. H02G 1/04

(52) U.S. Cl. CPC H02G 1/04

(57) ABSTRACT

The disclosures concerns a wire guide assembly with at least one sheave for stringing utility cable about utility structures such as towers and telephone poles. A wire guide assembly comprises: a plurality of plates forming a housing, a sheave, and a side gate with an elongated guide arm extending therefrom, wherein the side gate is pivotally attached to a plate of the housing forming a channel corresponding to a volume between the sheave, the side gate, and the housing, with the guide arm attached to the housing at an angle between 45 and 90 degrees. The wire guide assembly is further characterized in that the wire guide assembly can be used in suspension, or attached to a cross arm of a utility structure, wherein the elongated guide arm extending outwardly from assembly can be utilized for catching utility wire as it is introduced to the assembly via a helicopter.

### BACKGROUND

Field of the Invention

The invention relates to devices for guiding utility cables during installation, and more particularly, to a wire guide assembly for guiding installation of utility cables for mounting upon a structure.

Description of the Related Art

To lessen the environmental impact from the use of heavy trucks and equipment, and to improve the process of installing utility cables, utility companies have used helicopters to install utility cables upon new towers and utility poles (collectively “structures”), or to modify existing structures and pull new wires across the top of the structures. Linemen are often deployed hundreds of feet above the ground to guide the wire to the desired location atop the structures. Even when linemen are not deployed, helicopter pilots have to perform difficult and dangerous maneuvers to place the wire at the desired locations.

Thus, there is a need for a device and method to provide for easy and efficient guiding of utility cables into position.

### SUMMARY OF THE INVENTION

The disclosures concerns a wire guide assembly with at least one sheave for stringing utility cable about utility structures, such as towers and telephone poles. A wire guide assembly comprises: a plurality of plates forming a housing, at least one sheave coupled to the housing, and a side gate with an elongated guide arm extending therefrom. The side gate is pivotally attached to a plate of the housing forming a channel corresponding to a volume between the sheave, the side gate, and the housing. The guide arm is generally attached to the housing at an angle formed therewith. In some embodiments, the guide arm includes a catch hook.

The wire guide assembly is further characterized in that the wire guide assembly can be used in suspension, or attached to a cross arm, wherein the elongated guide arm extending outwardly from assembly can be utilized for catching utility wire as it is introduced to the assembly via a helicopter.

This is achieved by lowering the wire from the helicopter onto the catch arm. The wire is assisted onto the catch arm via the catch hook, and the weight of the wire forces the wire down, through the catch gate and into the channel. Once the wire clears the catch gate, the catch gate is forced back to its original position via a spring, nesting the wire inside the channel. Once the wire is nested inside the channel it is free to move through the device via the sheave, but is always restrained in the desired position atop the structure.

### BRIEF DESCRIPTION OF THE DRAWINGS

These and other features will be further understood by those with skill in the art upon a review of the appended drawings, wherein:

FIG. 1 shows a perspective view of a first disclosed embodiment of a wire guide assembly in which the wire guide is shown having a plurality of plates forming a housing, two sheaves, and a pivotally attached side gate, with a guide arm assembly protruding therefrom;

FIG. 2 shows a left side view in accordance with the first embodiment;

FIG. 3 shows a right side view in accordance with the first embodiment;

FIG. 4 shows a front view in accordance with the first embodiment;

FIG. 5A shows a rear view in accordance with the first embodiment;

FIG. 5B shows a rotatable shaft and a threaded bolt of the double sheave assembly in accordance with the first embodiment;

FIG. 6 shows a top view in accordance with the first embodiment;

FIG. 7 shows a bottom view in accordance with the first embodiment;

FIG. 8 shows a side gate, a shaft and a lock for attaching the side gate to a second outer mounting plate of the first embodiment;

FIG. 9 shows a guide arm, a guide arm support, and pins and rings for attaching the guide arm and the guide arm support to a first outer mounting plate in accordance with the first embodiment;

FIG. 10 shows a perspective view of a wire guide assembly in accordance with a second disclosed embodiment in which the wire guide is shown having a plurality of plates forming a body, one sheave, and a pivotally attached side gate, with a guide arm assembly protruding therefrom;

FIG. 11 shows a left side view in accordance with the second embodiment;

FIG. 12 shows a right side view of the single sheave assembly in accordance with the second embodiment;

FIG. 13 shows a front view of the single sheave assembly in accordance with the second embodiment;

FIG. 14 shows a rear view of the single sheave assembly in accordance with the second embodiment;

FIG. 15 shows a top view of the single sheave assembly in accordance with the second embodiment;

FIG. 16 shows a bottom view of the single sheave assembly in accordance with the second embodiment;

FIG. 17 shows a guide arm, a guide arm support, and a first outer mounting plate of the single sheave assembly in accordance with the second embodiment; and

FIG. 18 shows attachment of the single sheave assembly to a cross arm using a mount bracket, wherein the single sheave assembly is in accordance with the second embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments. However, a myriad of other embodiments which will not be expressly described will be readily understood by those having skill in the art upon a thorough review hereof. Accordingly, any reviewer of the instant disclosure should interpret the scope of the invention by the claims, and such scope shall not be limited by the embodiments described and illustrated herein.

In a general embodiment, a wire guide assembly is provided. The wire guide assembly comprises: a plurality of plates forming a housing, at least one sheave, and a side gate with an elongated guide arm extending therefrom. Wherein the side gate is pivotally attached to a plate of the housing forming a channel corresponding to a volume between the sheave, the side gate, and the housing. Wherein the guide arm extends outwardly from the channel and adjacent to the side gate for guiding a cable into the channel.

The wire guide assembly is further characterized in that the wire guide assembly can be used in suspension, or attached to a cross arm, wherein the elongated guide arm extending outwardly from assembly can be utilized for catching utility wire as it is introduced to the assembly via a helicopter.

In some embodiments the wire guide assembly plurality of plates comprise: a first housing plate, and a second housing plate where the second housing plate can be oriented parallel with the first and spaced apart therefrom. The first and second housing plates form a front and rear of the wire guide assembly, respectively. A top mounting plate can be disposed between the first and second housing plates at a top end of the wire guide assembly, and a bottom mounting plate can be disposed between the first and second housing plates at a bottom end of the wire guide assembly. An inner mounting plate can be disposed between the first and second housing plates at a first side of the wire guide assembly. With a first outer mounting plate disposed adjacent to each of the first and second housing plates and the bottom mounting plate, extending upwardly therefrom; and a second outer mounting plate disposed adjacent to each of the first and second housing plates and the top mounting plate, and extending downwardly therefrom; wherein a gap is disposed between the first and second outer mounting plates. Wherein the side gate is configured to extend between the first and second outer mounting plates in a home position and configured to rotate into a volume associated with the channel when actuated.

In some embodiments, the elongated guide arm comprises a catch hook disposed at a terminal end thereof opposite the channel.

The wire guide assembly is further characterized in that it can be used to deploy utility cable via a unique method. Said method comprises: (i) coupling a wire guide assembly to a tower or utility pole. (ii) contacting the utility cable at the elongated guide arm of the wire guide assembly; (iii) guiding the utility cable to the channel of the wire guide assembly using the elongated guide arm; (iv) capturing the utility cable within the channel using the side gate of the wire guide assembly; and (v)stringing the utility cable about the first sheave.

### Example 1

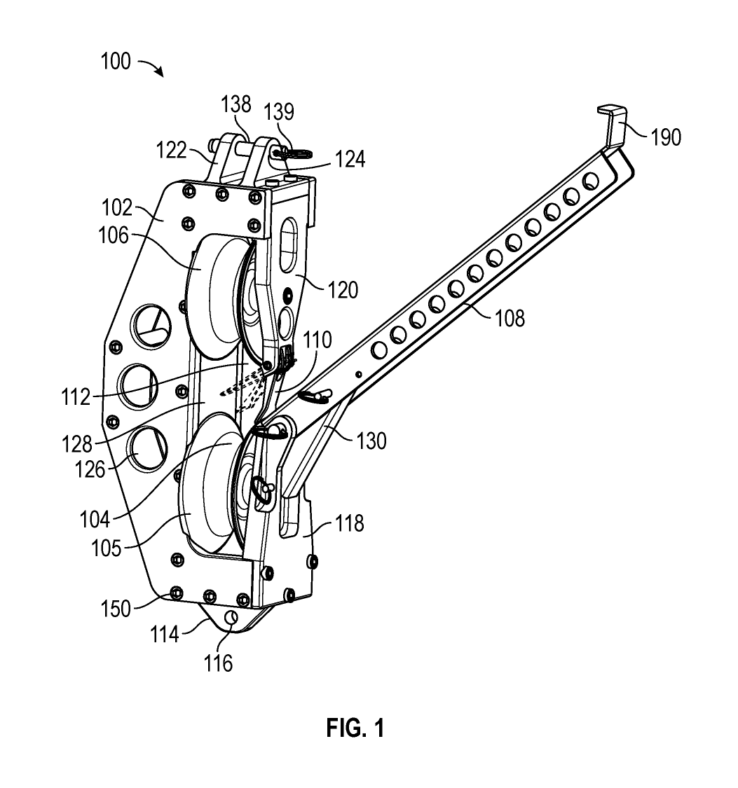

Now turning to the drawings, FIGS. 1-9 illustrate a wire guide assembly 100 according to a first embodiment. Unless otherwise noted, the descriptions herein refer to the wire guide 100 in upright positions as shown in FIGS. 1-5.

FIG. 1 shows a perspective view of a first disclosed embodiment of a wire guide assembly 100 in which the wire guide assembly is shown having a plurality of plates forming a body, two sheaves 105 and 106 and a pivotally attached side gate 110, with a guide arm assembly 108 and guide arm support 130 protruding therefrom. Disposed on said guide arm assembly 108 is a wire catch hook 190.

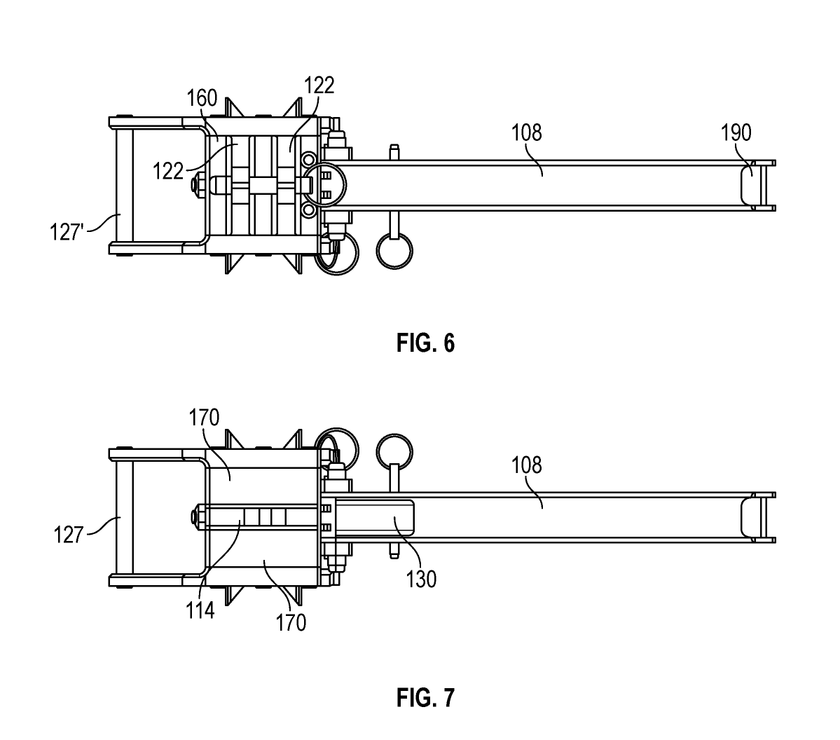

The first disclosed embodiment of a wire guide assembly 100 includes a first (or left) housing plate 102 and a second (or right) housing plate 102′ (FIG. 3, right side view) opposite of the first housing plate 102. The wire guide assembly 100 also includes a top mounting plate 160 (FIG. 6, top view), a bottom mounting plate 170 (FIG. 7, bottom view), a first outer (or lower) mounting plate 118, a second outer (or upper) mounting plate 120, and an inner mounting plate 128. In the illustrated embodiment, the body is formed by utilizing bolts 150 to join the plates of the body together. It can be appreciated by those with skill in the art, that this or alternatively any other attachment methods or devices known in the art. may be utilized to join the plates together to similarly form the body of the wire guide assembly.

The rotatably mounted sheaves 105 and 106 each includes a sheave groove 104, sized to fit utility cables, for example, telephone or electrical cables, known in the art. When the sheaves 105 and 106 are attached to the inner mounting plate 128 and to the first outer mounting plate 118 and second outer mounting plate 120, respectively, as described above, a channel 112 is formed between the sheaves 105 and 106, such that a cable will move freely inside the channel 112.

In FIG. 1, the first disclosed embodiment of the wire guide assembly is shown with an optional pair of suspension flanges 122, each with an aperture 124 therethrough for receiving a pin 138. In FIG. 1 the pin 138 has an optional ring 139. The suspension flange is useful in that it provides a means to suspend the wire guide assembly from a utility pole during use.

Additionally the first disclosed embodiment of a wire guide assembly is shown with an optional Mounting Flange 114 and Mounting Aperture 116. The mounting flange is configured to couple with a mounting bracket to attach the wire guide assembly to a utility pole during use.

In FIG. 1, the guide arm 108 may be attached to the first outer mounting plate 118 at an angle, for example, between 45 and 90 degrees, and include a catch hook 190. In some embodiments, three handle apertures 126 are positioned on the first (or left) housing plate 102 and the second (or right) housing plate 102′(FIG. 3, right side view). The apertures may be useful for carrying or handling the wire guide assembly 100.

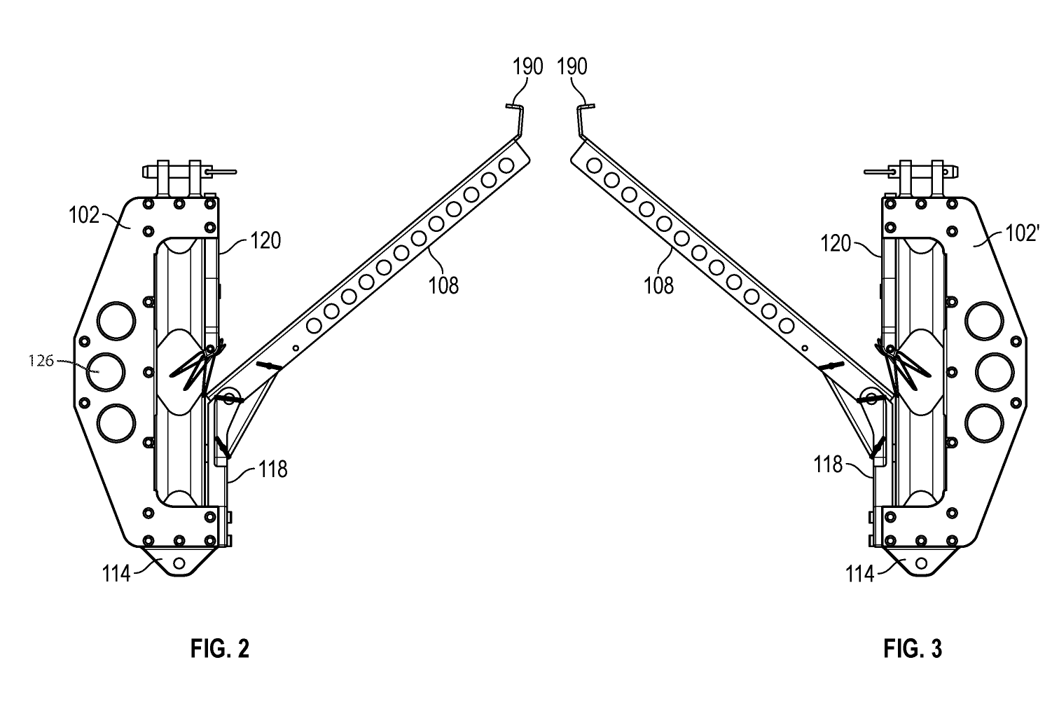

FIG. 2 shows a left side view of the first disclosed embodiment of a wire guide assembly 100 that comprises: a second outer (or upper) mounting plate 120 and first outer (or lower) mounting plate 118, a first housing plate 102, an optional Mounting Flange 114, and three handle apertures 126.

FIG. 3 shows a right side view (opposite FIG. 2) of the first disclosed embodiment of a wire guide assembly 100 that further comprises a second (or right) housing plate 102′.

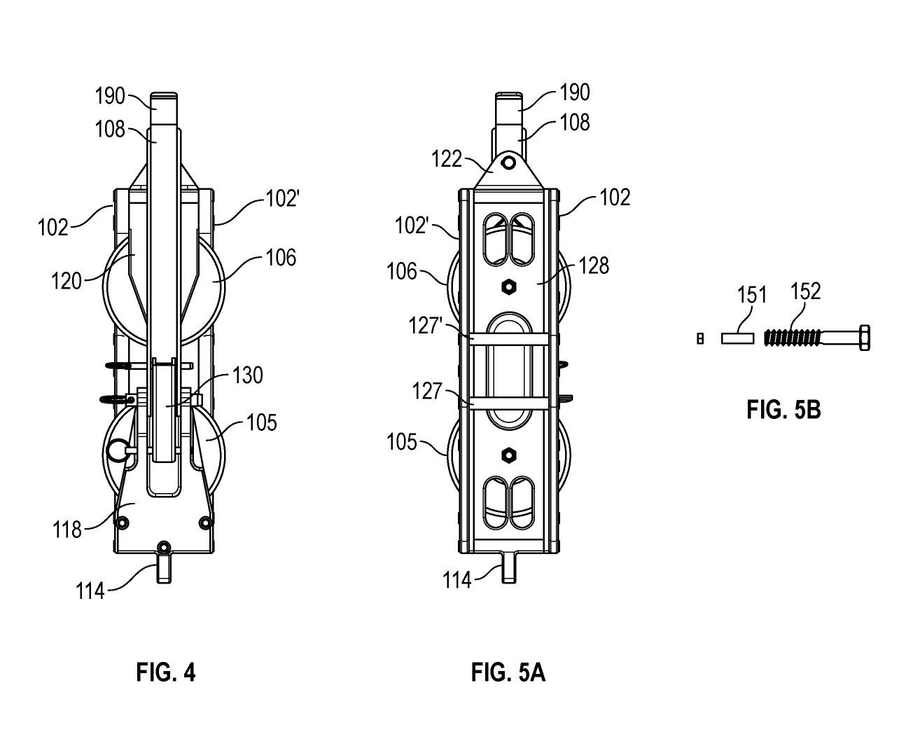

FIG. 4 shows a front view of the first disclosed embodiment of a wire guide assembly 100.

FIG. 5A shows a rear view of the first disclosed embodiment of a wire guide assembly 100. Here, the wire guide 100 includes a first (or lower) sheave 105 and a second (or upper) sheave 106. The lower sheave 105 is rotatably attached to the inner mounting plate 128 and the first outer mounting plate 118. The upper sheave 106 is rotatably attached to the inner mounting plate 128 and the second outer mounting plate 120. As shown in FIG. 5A and 5B, in some embodiments, the lower sheave 105 may be rotatably attached to the inner mounting plate 128 and the first outer mounting plate 118 using a first rotatable shaft 151 and threaded bolt 152, and suitable washers (not shown), such that the lower sheave 105 may freely rotate about the axis of the rotatable shaft 151. In the same manner, the upper sheave 106 may be rotatably attached to the inner mounting plate 128 and the second outer mounting plate 120 using a second rotatable shaft, threaded bolt, and suitable washers.

FIG. 5B shows a rotatable shaft 151 and threaded bolt 152 of the first disclosed embodiment of a wire guide assembly 100.

FIG. 6 shows a top view the first disclosed embodiment of a wire guide assembly 100, further showing the second (or upper) spacer 127′ and the top mounting plate 160.

FIG. 7 shows a bottom view of the first disclosed embodiment of a wire guide assembly 100, further showing the first (or lower) spacer 127 and the bottom mounting plate 170.

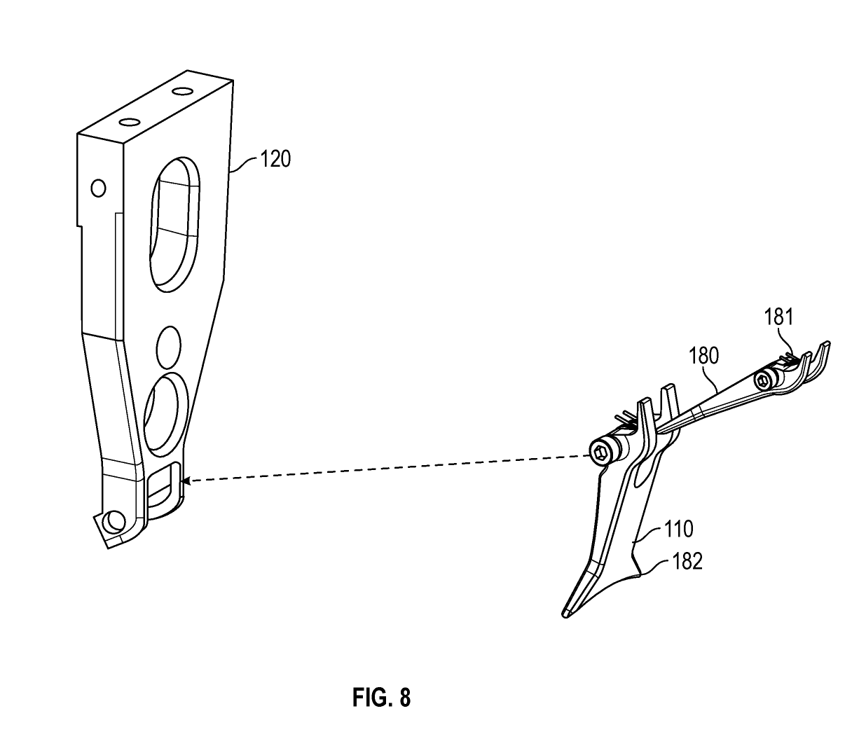

FIG. 8 shows a side gate 110, a spring shaft 180, and a lock 181 for attaching the side gate 110 to a second outer mounting plate 120 of the wire guide assembly 100. The side gate 110 may be pivotly attached to the lower end of the second outer mounting plate 120 using spring shaft 180 including springs therein, and a lock 181, such that the side gate 110 may freely pivot about the axis of the spring shaft 180. The side gate 110 is further shown to have flares 182, which act to stop the side gate 110 from pivoting back outwardly beyond its initial position.

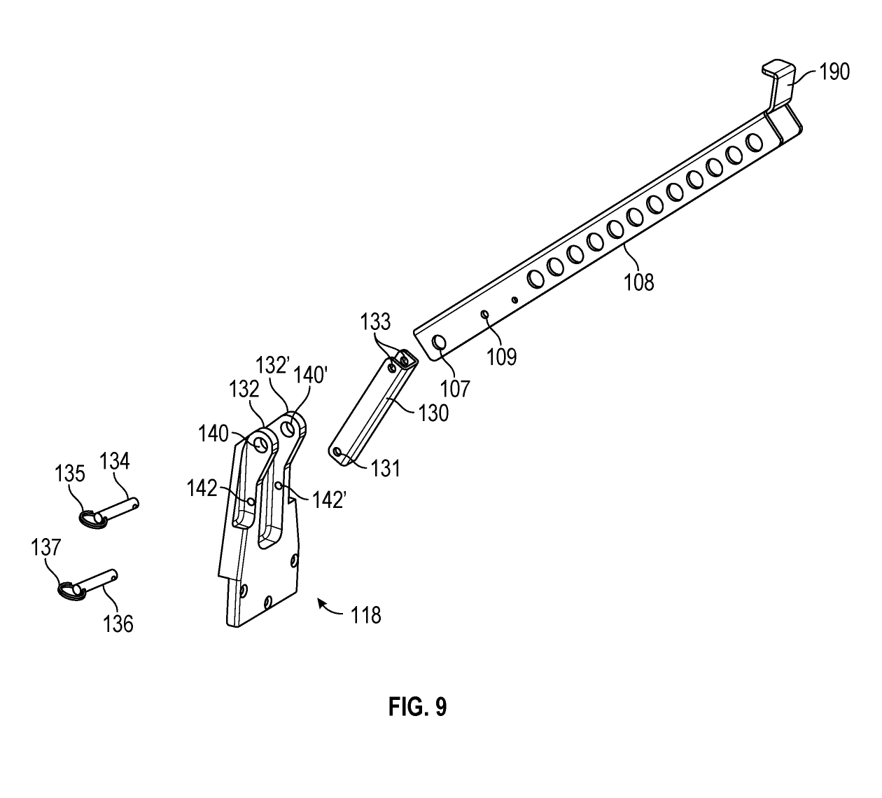

FIG. 9 shows a guide arm 108, a guide arm support 130, and pins and rings for attaching the guide arm 108 and the guide arm support 130 to a first outer mounting plate 118 of the first disclosed embodiment of a wire guide assembly 100.

The first outer mounting plate 118 may include a pair of flanges 132 and 132′ at its distal (or upper) end. The flange 132 and flange 132′ each includes respectively a circular aperture 142 and 142′ for attaching the proximal (or lower) end of a guide arm support 130, by aligning the circular apertures 142 and 142′ to a circular aperture 131 positioned near the lower end of the guide arm support 130. A pin 136 and ring 137 may be used to secure the lower end of the guide arm support 130 to the flanges 142 and 142′.

The flange 132 and flange 132′ each also includes respectively a circular aperture 140 and 140′ for attaching the proximal (or lower) end of a guide arm 108, by aligning the circular apertures 140 and 140′ of the flange 132 and flange 132′ to a circular aperture 107 positioned near the lower end of the guide arm 108. A pin 134 and ring 135 may be used to secure the guide arm 108 to the flanges 132 and 132′.

The guide arm support 130 also includes circular apertures 133 at its distal (or upper) end. The circular apertures 133 may be aligned with a circular aperture 109 positioned toward the lower end of the guide arm 108. A pin may be inserted through the apertures 133 of the guide arm support 130 and the aperture 109 of the guide arm 108 to secure the guide arm 108 to the guide arm support 130.

### Example 2

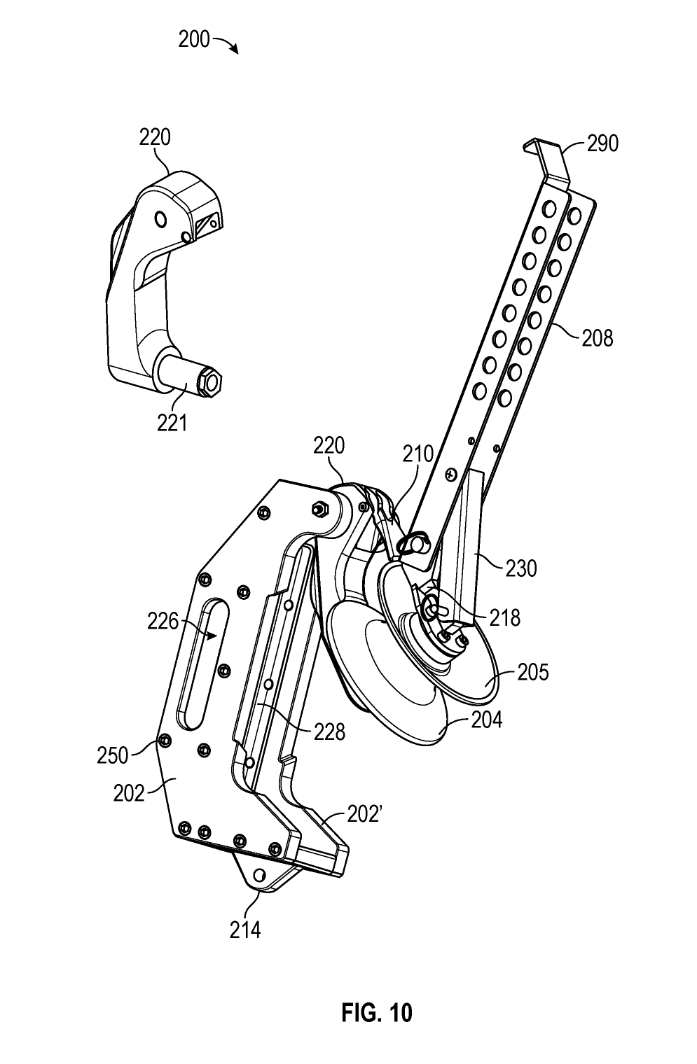

FIGS. 10-17, illustrate a wire guide assembly 200 according to a second embodiment. Unless otherwise noted, the descriptions herein refer to the wire guide 200 in an upright position as shown in FIGS. 10-14.

FIG. 10 shows a perspective view of a second disclosed embodiment of a wire guide assembly 200 in which the wire guide assembly is shown having a plurality of plates forming a body, one sheave 205 and a pivotally attached side gate 210, with a guide arm assembly 208 and guide arm support 230 protruding therefrom. Disposed on said a guide arm assembly 208 is a wire catch hook 290.

The body of the wire guide assembly 200 can include a first (or left) housing plate 202 and a second (or right) housing plate 202′ (FIG. 3, right side view) opposite of the first housing plate 202. The wire guide assembly 200 also includes a bottom mounting plate 270 (FIG. 16, bottom view), a first outer (or lower) mounting plate 218, a second outer (or upper) mounting plate 220, and an inner mounting plate 228. In this embodiment, the body is formed by utilizing nuts and bolts 150 to join the plates of the body together. It can be appreciated by those with skill in the art, that this or alternatively, any other attachment methods or devices known in the art may be utilized to join the plates together to similarly form the body of the wire guide assembly.

The wire guide 200 includes a sheave 205. The sheave 205 is rotatably attached to the second (or upper) mounting plate 220 at the proximal (or lower) end of the second mounting plate 220. The sheave 205 may be rotatably attached to the mounting plate 220 using the rotatable shaft 221 and the first mounting plate 218, such that the sheave 205 may freely rotate about the axis of the rotatable shaft 221.

The sheave 205 includes a sheave groove 204, sized to fit cables, for example, telephone or electrical cables, known in the art. When the sheave 205 is attached to the mounting plate 220, a channel 212 is formed between the sheave 205 and the mounting plate 220, such that a cable will move freely inside the channel 212.

The mounting plate 220 includes at its distal (or upper) end a side gate 210. In some embodiments, the side gate 210 may be pivotly attached to the upper end of the mounting plate 218 using a shaft and lock (not shown), such that the side gate 210 may freely pivot about the axis of such shaft.

The mounting plate 220 may be pivotly attached to the first (or left) housing plate 202 and the second (or right) housing plate 202′ using a cylindrical shaft (not shown), such that the mounting plate 200 may freely pivot about the axis of such shaft, as illustrated in FIG. 10 where the mounting plate 220, with the attached sheave 205, pivots upwardly and outwardly.

In some embodiments, the guide arm 208 may be attached to the first outer mounting plate 218 at an angle, for example, between 45 and 90 degrees. The guide arm 208 includes a catch hook 290. In some embodiments, one or more handle apertures 226 are positioned on the first housing plate 202 and the second housing plate 202′. In some exemplary operations, the one or more handle apertures may be used for carrying or handling the wire guide assembly 200.

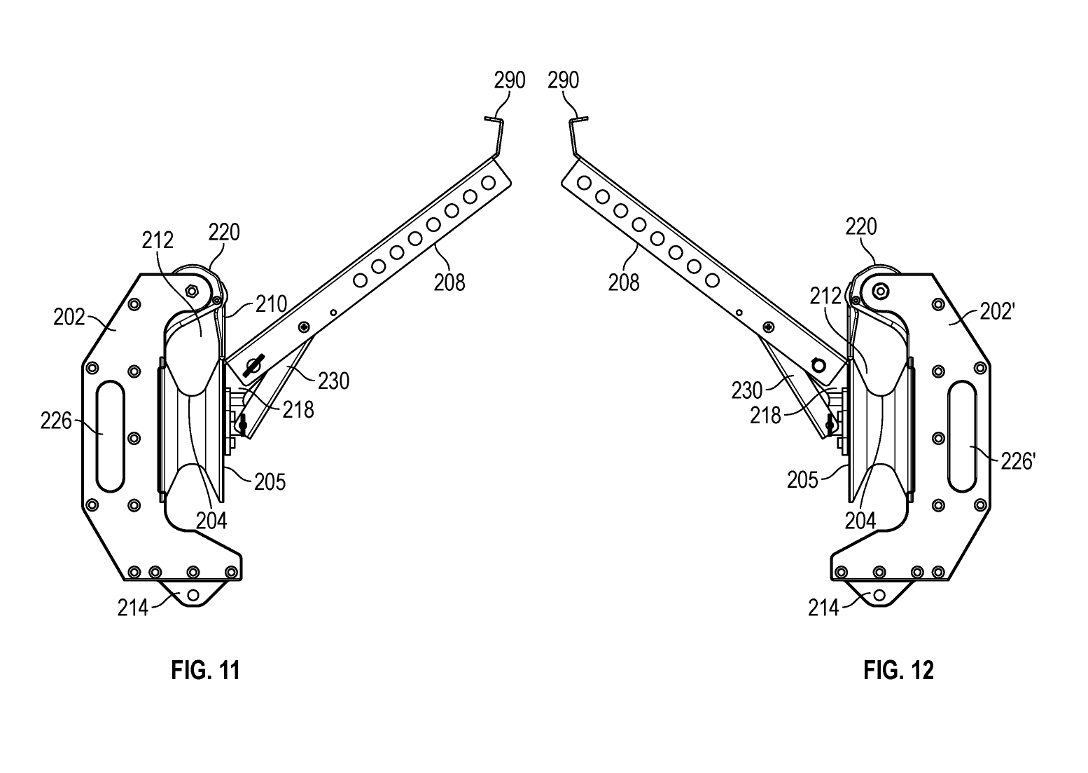

FIG. 11 shows a left side view of the second embodiment of the wire guide assembly 200 that comprises: a second outer (or upper) mounting plate 220 and first outer (or lower) mounting plate 218, a first housing plate 202, an optional Mounting Flange 214, and a handle aperture 226.

The wire guide assembly 200 is shown to have a single sheave 205, whose sheave groove 204 forms a channel with the body of the wire guide assembly and the slide gate 210

FIG. 12 shows a right side view of the second embodiment of the wire guide assembly 200 that further comprises: a second housing plate 202′, a guide arm support 230, and a guide arm 208 mounted with a catch hook 290.

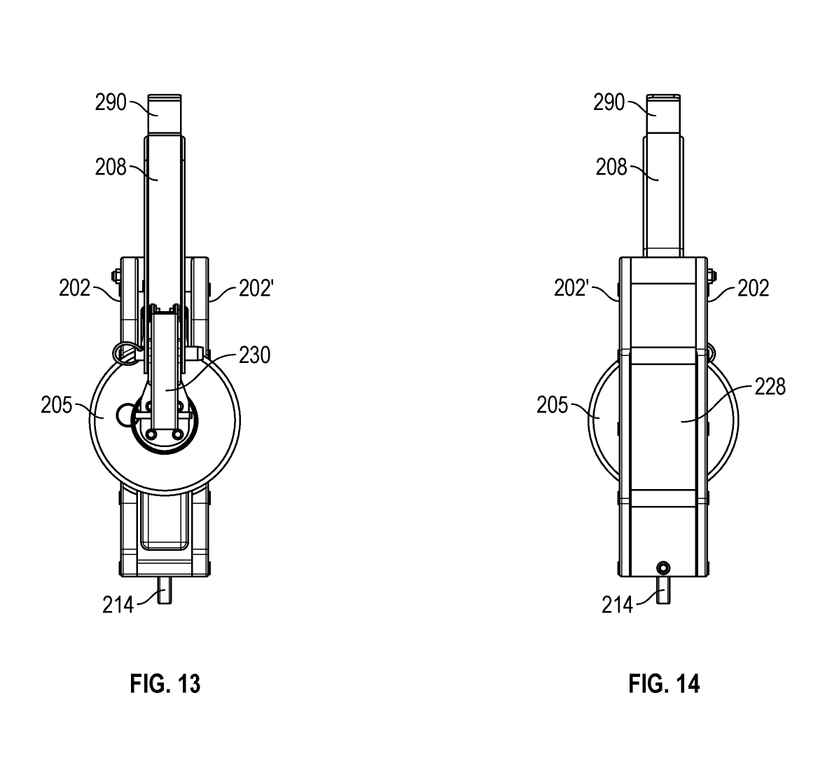

FIG. 13 shows a front view of the second embodiment of the wire guide assembly 200.

FIG. 14 shows a rear view of the second embodiment of the wire guide assembly 200.

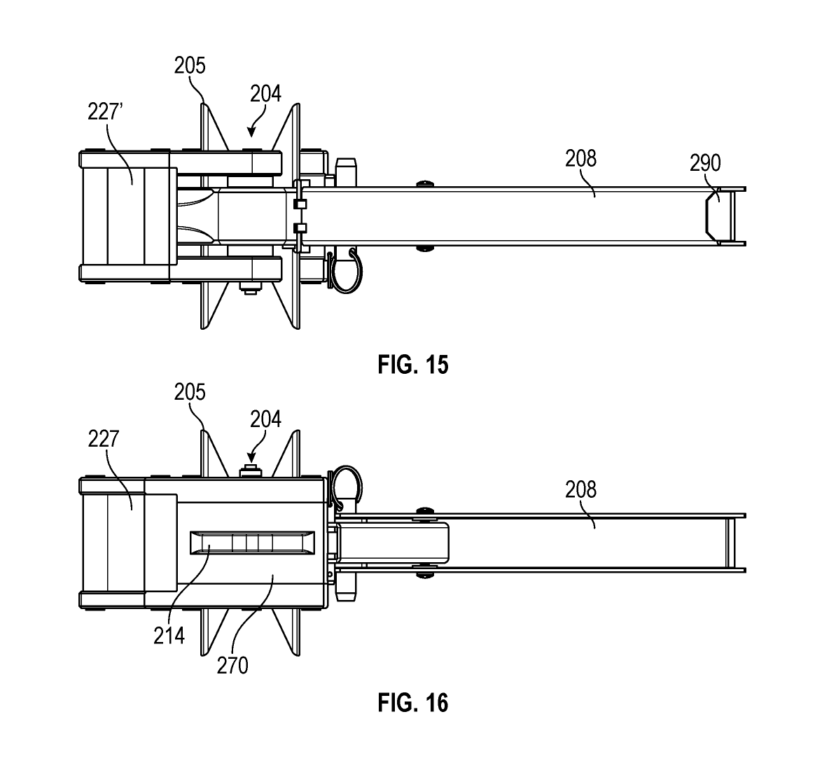

FIG. 15 shows a top view of the second embodiment of the wire guide assembly 200 with a second or upper spacer 227′.

FIG. 16 shows a bottom view of the second embodiment of the wire guide assembly 200 with a top plate 270, and a first or lower spacer 227.

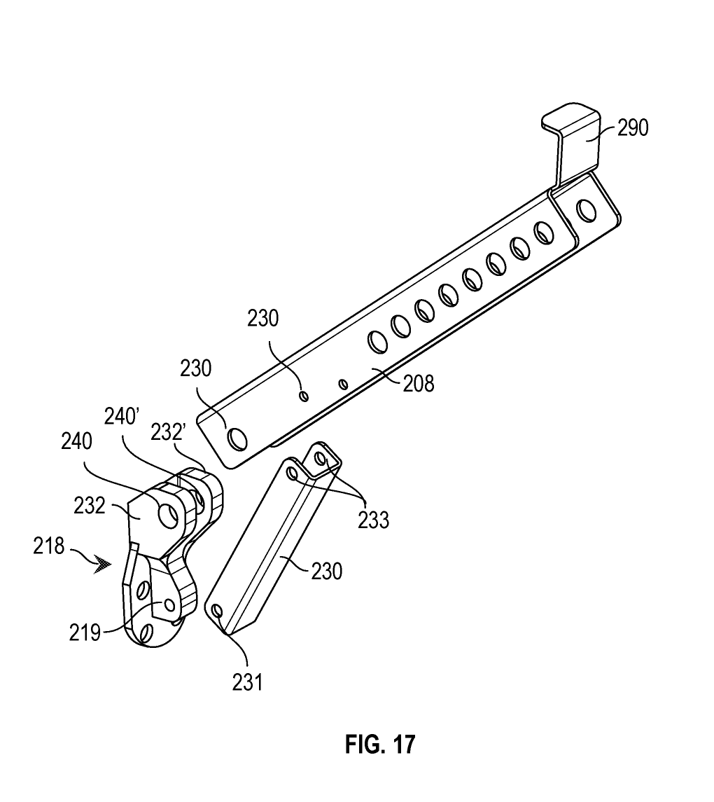

FIG. 17 shows a guide arm 208, a guide arm support 230 attaching to a first outer mounting plate 218 of the second disclosed embodiment of a wire guide assembly 200.

The first outer mounting plate 218 may include a pair of flanges 232 and 232′ at its distal (or upper) end. The flange 232 and flange 232′ each includes respectively a circular aperture 240 and 240′ for attaching the proximal (or lower) end of a guide arm support 230, by aligning the circular apertures 240 and 240′ to a circular aperture 207 positioned near the lower end of the guide arm 208. A pin (not shown) may be used to secure the lower end of the guide arm 208 to the flanges 240 and 240′.

The flange 219 includes a circular aperture 242 for attaching the proximal (or lower) end of a guide arm support 230, by aligning the circular aperture 242 of the flange 219 to a circular aperture 231 positioned near the lower end of the guide arm support 230. A pin and ring (not shown) may be used to secure the guide arm support 230 to the flanges 219.

The guide arm support 230 also includes circular apertures 233 at its distal (or upper) end. The circular apertures 233 may be aligned with a circular aperture 209 positioned toward the lower end of the guide arm 208. A pin may be inserted through the apertures 233 of the guide arm support 230 and the aperture 209 of the guide arm 208 to secure the guide arm 208 to the guide arm support 230.

### Example Method of Use

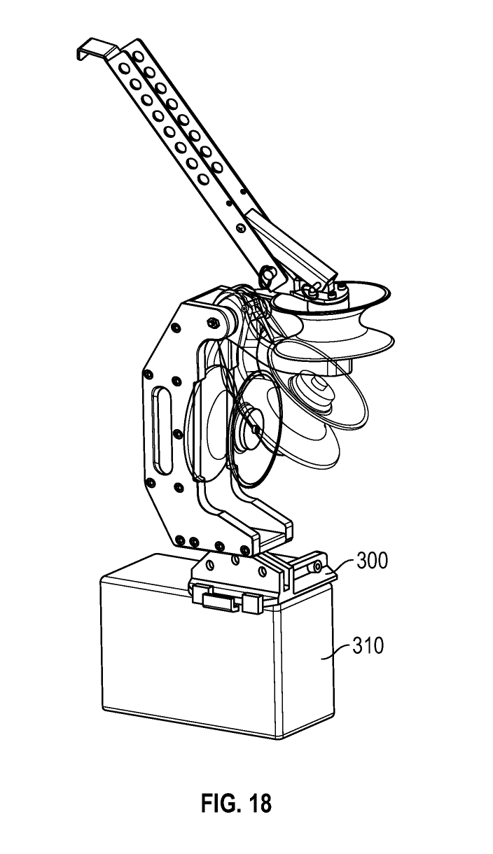

FIG. 18 shows the second embodiment (Example 2) of the wire guide assembly 200 deployed for use upon a utility pole. Here the wire guide assembly 200 is shown attached to a crossarm 310 via an optional mount bracket 300. The mount bracket 300 may be attached to the cross arm 310 using, for example, a ratchet strap (not shown). The mounting flange 214 of the wire guide assembly 200 may then be attached to the mount bracket 300.

With one or more wire guide assembly 200 attached to one or more utility poles (for example, about 20 to 30 poles), a helicopter may then drop a cable onto the guide arm 208. The catch hook 290 may help catch or guide the cable as it is being dropped or pulled from pole to pole. The angular slope of the guide arm 208 in relation to the first mounting plate 218 will cause the cable to slide down toward the lower end of the guide arm 208. The force of the slide and the weight of the cable will cause the side gate 210 to pivot upwardly and inwardly toward the channel 212, such that the cable will rest on the sheave groove 204 of the sheave 205. As such, the sheave 205 will rotate as the cable is pulled. The side gate 210 will drop back to its pre-pivoting position. The side gate 210 includes a flare which acts to stop the side gate 210 from pivoting outwardly beyond its pre-pivoting position. Alternatively, the angular slope of the guide arm 208 will also stop the side gate 210 from pivoting outwardly beyond its pre-pivoting position.

When the elevations of the utility poles vary, the sheave 205 will pivot upwardly or downwardly as needed while the cable is being pulled or installed. In yet some other exemplary operations, when the utility poles are not in line with one another, for example, not in a substantially straight line, to accommodate a turn from one utility pole to the next while installing or pulling a cable, the sheave 205 will also pivot upwardly or downwardly as needed.

The wire guide assembly 100 may be used the same way. The wire guide assembly 100 may attached to a cross arm 310 of a utility pole, for example, a telephone or power pole, using a mount bracket 300 (as illustrated in FIG. 18). The mount bracket 300 may be attached to the cross arm 310 using, for example, a ratchet strap (not shown). The mounting flange 114 of the wire guide assembly 100 may then be attached to the mount bracket 300.

With one or more wire guide assemblies 100 attached to one or more utility poles (for example, about 20 to 30 poles), a helicopter may then drop a cable onto the guide arm 108. The catch hook 190 may help catch or guide the cable as it is being dropped or pulled from pole to pole. The angular slope of the guide arm 108 in relation to the first mounting plate 118 will cause the cable to slide down toward the lower end of the guide arm 108. The force of the slide and the weight of the cable will cause the side gate 110 to pivot upwardly and inwardly toward the channel 112, such that the cable will rest on the sheave groove 104 of the lower sheave 105. As such, the sheave 105 will rotate as the cable is pulled. The side gate 110 will drop back to its pre-pivoting position. The side gate 110 includes a flare 182 (see FIG. 8) which acts to stop the side gate 110 from pivoting outwardly beyond its pre-pivoting position. Alternatively, the angular slope of the guide arm 108 will also stop the side gate 110 from pivoting outwardly beyond its pre-pivoting position.

When the utility poles are in line with one another, for example, in a substantially straight line, the wire guide assembly 100 will be used. In these operations, the elevation of a utility pole may be different from the next utility pole in line. When the elevation of the next utility pole is higher, for example, the cable will rest against the sheave groove of the upper sheave 106, and still being secured within the channel 112 of the wire guide assembly 100. The sheave 106 will rotate as the cable is pulled.

Now, although particular features and embodiments have been described in an effort to enable those with skill in the art to make and use the claimed invention, it should be understood that several variations, alterations or substitutions can be achieved to fabricate and operate the wire guide assembly. Nothing in this description shall be construed as limiting the spirit and scope of the invention as set forth in the appended claims, below.

### FEATURE LIST

(100; 200) Wire Guide assembly
(102; 202) Left Housing Plate
(102′; 202′) Right Housing Plate
(104; 204) Sheave Groove
(105; 205) Lower Sheave
(106) Upper Sheave
(107; 207) circular aperture positioned near lower portion of guide arm
(108; 208) Guide Arm
(109) circular aperture
(110; 210) Side gate
(112; 212) Channel
(114; 214) Mounting Flange
(116; 216) Mounting Flange Aperture
(118; 218) First Outer or Lower Mounting Plate
(120; 220) Second Outer or Upper Mounting Plate
(122) Suspension Flange
(124) circular aperture
(126; 226) Handle Apertures
(127; 227) First or Lower Spacer
(127′; 227′) Second or upper spacer
(128; 228) Inner Mounting Plate
(130; 230) Guide Arm Support
(131) Circular aperture
(132; 232) Mounting Plate Flange
(132′; 232′) Mounting Plate Flange
(133) Circular apertures
(134) Pin
(135) Ring
(136) Pin
(137) Ring
(140) Circular aperture
(140′) Circular aperture
(142) Circular aperture
(142′) Circular aperture
(150; 250) Bolt
(151) Rotatable Shaft
(152) Threaded Bolt
(160) Top mounting plate
(170; 270) Bottom Mounting Plate
(180) Spring Shaft
(181) Lock
(182) Side Gate Flare
(190; 290) Catch Hook
(219) Mounting Plate Flange
(221) Rotatable Shaft
(300) Mounting Bracket
(310) Utility Pole Cross arm

1. A wire guide assembly, comprising:
a plurality of plates coupled together to form a housing;
a first sheave coupled to the housing, wherein the first sheave is configured to rotate about a first sheave axis; and
a side gate rotatably coupled to the housing and extending to the first sheave, wherein a channel is formed between the housing, first sheave, and the side gate;
characterized in that:
the wire guide assembly further comprises an elongated guide arm extending outwardly from the channel and adjacent to the side gate for guiding a cable into the channel.

2. The wire guide assembly of claim 1, wherein said plurality of plates comprises:
a first housing plate, and a second housing plate oriented parallel with the first housing plate and spaced apart therefrom, the first and second housing plates forming a front and rear of the wire guide assembly, respectively;
a top mounting plate disposed between the first and second housing plates at a top end of the wire guide assembly;
a bottom mounting plate disposed between the first and second housing plates at a bottom end of the wire guide assembly;
an inner mounting plate disposed between the first and second housing plates at a first side of the wire guide assembly;
a first outer mounting plate disposed adjacent to each of the first and second housing plates and the bottom mounting plate, and extending upwardly therefrom; and
a second outer mounting plate disposed adjacent to each of the first and second housing plates and the top mounting plate, and extending downwardly therefrom;
wherein a gap is disposed between the first and second outer mounting plates.

3. The wire guide assembly of claim 2, wherein the side gate is configured to extend between the first and second outer mounting plates in a home position and wherein the side gate is further configured to rotate into a volume associated with the channel when actuated.

4. The wire guide assembly of claim 1, wherein elongated guide arm comprises a catch hook disposed at a terminal end thereof opposite the channel.

5. A method for stringing utility cable about a tower or utility pole, the method comprising:
coupling a wire guide assembly to the tower or utility pole, the wire guide assembly comprising:
a plurality of plates coupled together to form a housing; a first sheave coupled to the housing, wherein the first sheave is configured to rotate about a first sheave axis; and a side gate rotatably coupled to the housing and extending to the first sheave, wherein a channel is formed between the housing, first sheave, and the side gate; characterized in that: the wire guide assembly further comprises an elongated guide arm extending outwardly from the channel and adjacent to the side gate for guiding a cable into the channel;
contacting the utility cable at the elongated guide arm of the wire guide assembly;
guiding the utility cable to the channel of the wire guide assembly using the elongated guide arm;
capturing the utility cable within the channel using the side gate of the wire guide assembly; and
stringing the utility cable about the first sheave.
